(19) United States
(12) Patent Application Publication
(10) Pub. No.: US 2011/0113106 A1
(43) Pub. Date: May 12, 2011

(54) THROTTLE ON PRESENCE

(76) Inventors: Mikael Klein, Huddinge (SE); Christer Boberg, Tungelsta (SE); Sofie Lassborn, Sollentuna (SE); Anders Lindgren, Alvsjo (SE)

(21) Appl. No.: 12/864,756

(22) PCT Filed: Jan. 28, 2008
(86) PCT No.: PCT/SE2008/050107

§ 371 Date: Sep. 7, 2010

(51) Int. Cl. G06F 15/16

(52) U.S. Cl. 709/206

(57) ABSTRACT

The present invention relates to throttle and rate limitation of notifications in a communication network, in particular to a method and devices for operating a communication network, e g a communication network comprising a presence system A method for operating a communication network for communicating with entities is provided, the method comprising the steps of receiving a first message from a first entity, the first message indicating delay parameter values for different parameters, receiving a second message from a second entity, selecting a delay parameter value in the communication network depending on the received second message and the delay parameter values in the first message, and sending a notification to the first entity according to the selected delay parameter value Further the present invention relates to devices implementing the method.

### TECHNICAL FIELD

The present invention relates to throttle and rate limitation of notifications in a communication network, in particular to a method and devices for operating a communication network, e.g. a communication network comprising a presence system.

### BACKGROUND

Current IETF documents, e.g. draft-niemi-sipping-event-throttle-05, define throttle and rate limitation on notifications. Throttle values may be set by the client subscribing to presence, and rate limitations may be set in the server on notification frequency. Throttle and rate limitations are valuable for reducing the number of messages sent in the communication network and in particular over the air interface in a mobile or wireless communication network.

In existing standardized functionality throttle is mapped to the whole service/event, which a subscriber in the communication network is subscribing to.

WO 2007/069992 describes selective rate limitation decided by a presentity and a presence server in order to reduce publication frequency from a presentity.

There is a need for further controlling the signaling in a communication network, e.g. a presence network, in particular over the air interface.

### SUMMARY

Accordingly, it is an object of the present invention to control and optimize signaling in a presence network.

Further, it is an object of the present invention to improve the user experience for a subscriber to notifications.

Accordingly, a method for operating a communication network, e.g. comprising a presence system, adapted to communicate with entities is provided, the method comprising the steps of: receiving a first message from a first entity, the first message indicating delay parameter values for different parameters, such as presence parameters; receiving a second message from a second entity; selecting a delay parameter value depending on the received second message and the delay parameter values in the first message; and sending a notification to the first entity according to the selected delay parameter value.

The different parameters may be presence attributes and/or presence contacts, such as presentities.

It is an important advantage of the present invention that a subscriber is enabled to differentiate the throttle for different parts of the content of the notifications.

It is an important advantage of the present invention that a subscriber, e.g. a watcher, in a network, e.g. adapted for presence, is able to control, e.g. limit or increase, throttle values for different types of data to be notified. Thereby the invention enables a subscriber to selectively and individually configure throttle for different types of data, e.g. presence data, such as presence attributes and/or presence contacts, providing improved user friendliness.

According to a further aspect of the present invention, a presence server for a presence system for communicating with entities and comprising a memory is provided. The presence server is adapted to: receive a first message from a first entity, the first message indicating delay parameter values for different presence parameters; receive a second message from a second entity; selecting a delay parameter value in the presence system depending on the received second message and the delay parameter values in the first message; select a delay parameter value depending on the received second message and the delay parameter values in the first message, and send a notification to the first entity according to the selected delay parameter value.

Further, a resource list server (RLS) for a presence system for communicating with entities, e.g. a presence server, a watcher and a RLS XDMS, is provided. The resource list server is adapted to: receive a first message from a first entity, the first message indicating delay parameter values for different presence parameters; receive a second message from a second entity; select a delay parameter value depending on the received second message and the delay parameter values in the first message; and send a notification to the first entity according to the selected delay parameter value.

According to a further aspect of the present invention, a watcher entity for a communication network comprising a presence system is provided, wherein the watcher entity is adapted to send a first message to the presence system, the first message comprising delay parameter values for different presence parameters, e.g. including a first delay parameter value for a first presence parameter and a second delay parameter value for a second presence parameter.

The watcher client may be any entity in the communication network implementing a watcher, e.g. an Application Server or a User Equipment, and may be embodied in or run on e.g. a mobile terminal, a PDA, a laptop, a personal computer, a server or any other suitable equipment.

The parameters, e.g. presence parameters, may comprise a first presence attribute and a second presence attribute and/or may comprise a first presentity and a second presentity. Delay parameters may be set for any suitable parameter used for distinguishing between different throttle settings.

Further in accordance with the present invention, a XDM server for a communication network for communicating with entities including a first entity and a second entity is provided. The XDM server is adapted to: receive a first message from an entity, e.g. the first entity or the second entity, the first message indicating delay parameter values for different documents, e.g. presence documents; receive a second message from the second entity; select a delay parameter value depending on the received second message and the delay parameter values in the first message; and send a notification to the first entity according to the selected delay parameter value.

The XDM server according to the invention may be employed in any IMS and/or SIP network comprising XDMSs.

It is an important advantage of the present invention that a subscriber with only one subscription can initiate push based subscriptions for some contacts and push/pull based subscriptions for other contacts.

If a subscriber is paying for the traffic, it is important that the subscriber can control and prioritize notifications. Accordingly it is an important advantage of the present invention that a subscriber when charging is applied is able to control and minimize the costs for notifications by prioritizing notifications, e.g. by setting different throttle values for notifications regarding different contacts and/or attributes.

The present invention is in particular intended for use in a presence SIMPLE based communication network, such as an IMS (IP Multimedia Subsystem) and/or an OMA (Open Mobile Alliance) system. However, the present invention may be implemented in any communication system or network employing presence.

### BRIEF DESCRIPTION OF THE DRAWINGS

The above and other features and advantages of the present invention will become readily apparent to those skilled in the art by the following detailed description thereof, in particular by detailed description of exemplary embodiments thereof with reference to the accompanying drawings, in which:

FIG. 1 illustrates an embodiment of the method according to the invention,

FIG. 2 schematically illustrates a communication network applying the method according to the present invention,

FIG. 3 schematically illustrates a communication network applying the method according to the present invention,

FIG. 4 illustrates signalling in a communication network according to an embodiment of the present invention,

FIG. 5 illustrates signalling in a communication network according to an embodiment of the present invention,

FIG. 6 illustrates signalling of an embodiment applying throttle on presence attributes,

FIGS. 7-10 illustrate signalling of embodiments applying throttle on presentities,

FIG. 11 illustrates signalling of an embodiment applying throttle on watcher info,

FIG. 12 illustrates signalling of an embodiment applying throttle on subscription for document changes, and

FIGS. 13-16 illustrate function block diagrams of embodiments of different entities in the network.

### DETAILED DESCRIPTION

The figures are schematic and simplified for clarity, and they merely show details which are essential to the understanding of the invention, while other details have been left out. Throughout, the same reference numerals are used for identical or corresponding parts or features.

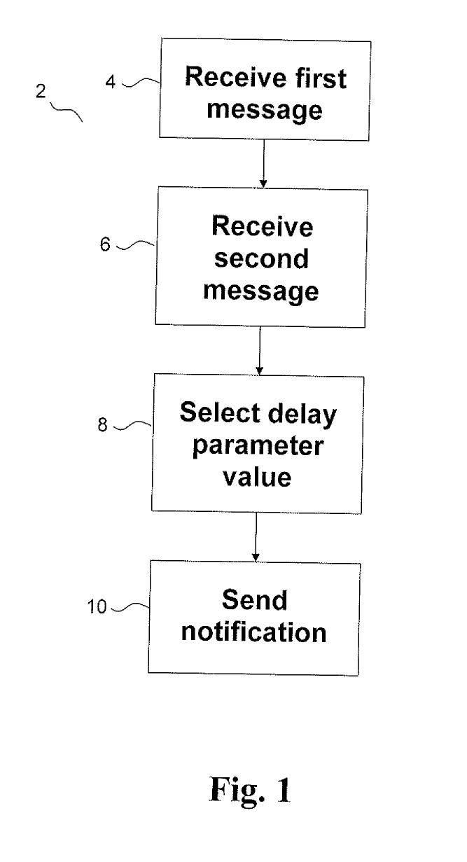

FIG. 1 illustrates an embodiment of the method according to the present invention. The method 2 for operating a communication network, e.g. a communication network comprising a presence system, for communicating with entities comprises the step 4 of receiving a first message from a first entity. The first message indicates delay parameter values for different presence parameters. Further, the method 2 comprises the step 6 of receiving a second message from a second entity and subsequently the method proceeds to step 8 of selecting a delay parameter value in the presence system depending on the received second message and the delay parameter values in the first message. Upon selecting the delay parameter value, the method proceeds to step 10 of sending a notification to the first entity according to the selected delay parameter value.

In the method according to the invention, the first message and the second message may be a number of different messages.

In an embodiment, the first message may be a subscription message, e.g. from a watcher sending a subscription message to an entity in the presence system, such as the presence server or the resource list server, from a presentity subscribing to watcher info by sending a subscription message to the presence server and/or from a XDM client subscribing to document changes in the system by sending a subscription message to a document server, such as XDMS. In addition or alternatively, the first message may be a PUT message, e.g. from a watcher sending a resource list to the presence system, wherein the resource list comprises delay parameter values for different contacts.

Furthermore, the second message may be a publication message, e.g. from a presentity publishing presence data. The second message may be a subscription message, e.g. from a watcher subscribing to presence data, and/or a PUT message, e.g. from a XDM client sending presence data to an XDMS. As an alternative or in combination with the other message types, the second message may be a notification message, e.g. from a presence server to a resource list server, the second message notifying presence data of a presentity.

The delay parameter values comprised in the first message may apply to one or more presence attributes. For example, a first delay parameter value may be set for a first presence attribute, such as mood, location and the like, and a second delay parameter value may be set for a different second presence attribute, e.g. location, mood, and the like. Any number of delay parameter values may be set in the first message.

The delay parameter values comprised in the first message may apply to one or more presentities or presence contacts. For example, a first delay parameter value may be set for a first presentity, e.g. person A, and a second delay parameter value may be set for a different second presentity, e.g. person B. Any number of delay parameter values may be set for any number of presentities in the first message. In an embodiment of the present invention, the first message comprises a set of delay parameter values for each presentity, e.g. a maximum and minimum delay parameter value for each presentity.

In the first message, a delay parameter value may be set for a group of attributes and/or a group of presentities.

Delay parameter values may be set in any suitable way, e.g. in a filter and/or in an XML document extension or the like.

In order to further improve user controllability, a delay parameter value may be set for a combination or set of different presence parameters.

Thus, in the first message, a delay parameter value may be set for a combination of different presence parameters. For example, a first delay parameter may be set for a first presentity and a first attribute, a second delay parameter may be set for a first presentity and a second attribute, a third delay parameter may be set for a second presentity and a first attribute, and/or a fourth delay parameter may be set for a second presentity and a second attribute.

In the method according to the invention, the step of selecting a delay parameter value may comprise selecting a first delay parameter value in case the second message comprises a first presence parameter and/or a first combination or set of presence parameters, and selecting a different second delay parameter value in case the second message comprises a second presence parameter and/or a second combination or set of presence parameters.

The step of selecting a delay parameter value may comprise selecting a maximum and/or a minimum delay parameter value for a presence parameter and/or a combination or set of presence parameters.

In an embodiment of the method according to the invention, the step of sending a notification comprises sending a notification comprising updated presence data to a watcher.

Furthermore, the step of sending a notification may comprise sending a notification comprising watcher info, e.g. “Watcher A pending”, about a watcher to a watcher info subscriber, e.g. a presentity.

In an embodiment of the method according to the invention, the step of sending a notification comprises sending a notification about document changes on an XDM server in the presence system to a subscriber.

The step of selecting a delay parameter value may comprise selecting a throttle value indicated in the first message.

In an embodiment of the present invention, the step of selecting a delay parameter may comprise selecting a rate limitation value, e.g. selecting preconfigured delay parameter value from a server in the presence system in case the first message does not comprise a delay parameter value for a certain presence parameter or combination of presence parameters.

The delay parameter values for different presence parameters may be stored in a memory in the presence system, e.g. on the presence server, on the resource list server, or on the presence XDMS.

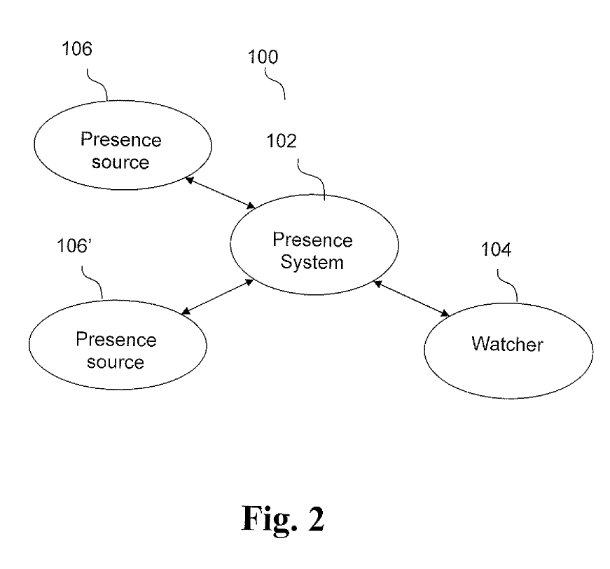

In FIG. 2, a communication network applying the method according to the present invention is schematically illustrated. The communication network 100 is an IETF SIMPLE network comprising a Presence System 102 implementing presence functionality and communicating with one or more Watchers 104 and one or more Presence Sources 106, 106′ as illustrated by the double arrows, e.g. via SIP and/or XCAP. Any suitable protocol may be used for communication in the network. The present invention enables a subscriber to selectively control (limit or increase) the amount of notifications sent from the system and thereby enable a subscriber to differentiate or prioritize notifications based on different presence parameters of the subscription. Thus, it is an advantage that the present invention enables more optimal subscriber initiated control of signaling in a presence network.

The communication network may be any communication network implementing presence, e.g. a network as specified by Open Mobile Alliance (see e.g. OMA-TS-Presence_SIMPLE-V2_{—}0-20071128-D of 28 Nov. 2007, earlier versions also applicable). The communication network may comprise or constitute an IP Multimedia Subsystem (IMS) network.

The present invention provides a high degree of freedom for a subscriber to control the rate of notifications received from the presence system, which is important in particular when charging is applied in order to efficiently optimize costs for notifications.

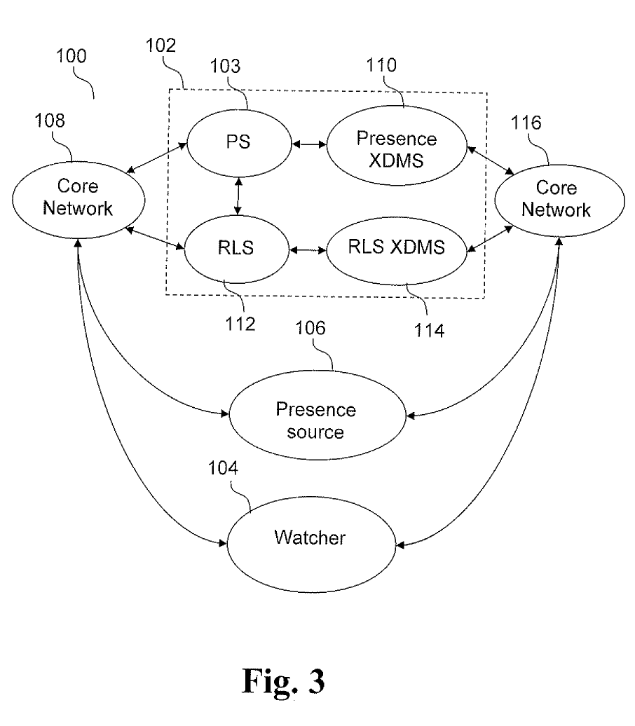

FIG. 3 schematically illustrates an embodiment of the network in FIG. 2. The communication network 100 is an IMS network applying the method according to the present invention. In the presence IMS network 100, the Presence System 102 comprises the entities Presence Server (PS) 103, presence document server (Presence XDMS) 110, optional Resource List Server (RLS) 112, and resource list document server (RLS XDMS) 114. The Presence Server 103 and the RLS 112 communicates, e.g. via SIP, with entities comprising one or more Watchers 104 and one or more Presence Sources 106 via core network 108, e.g. including a CSCF. Further, Presence Sources 106 and Watchers 104 may update, e.g. via XCAP, presence rules, resource lists, authorizations in the Presence XDMS 110 and the RLS XDMS 114 via core network 116, e.g. comprising an Aggregation Proxy.

The Presence Server (PS) 103 is an entity that accepts, stores and distributes presence information by handling publications from Presence Source(s) 104 of presentities, composing presence information from Presence Source(s) 104, handling subscriptions from Watchers 106 to presence information, and updating presence information when changes occur. The Presence Server 103 exchanges information with Presence XML Document Manipulation Server (Presence XDMS) 110 comprising a database for storage of documents related to presentities, e.g. subscription authorization rules and presence content rules for watchers. The Presence System 102 may further comprise a Resource List Server (RLS) 112 which accepts and manages subscriptions to presence lists, thereby enabling a Watcher to subscribe to multiple presentities by using only a single subscription transaction. The RLS 112 stores and retrieves presence lists of watchers in the RLS XDMS 114 comprising a database for storing presence lists.

The Presence XDMS may be divided into one or more XDMS's, each XDMS handling a certain task, e.g. one XDMS for handling authorizations and another XDMS for handling throttle and rate limitations.

The different entities in the communication network, such as presence sources, watchers, the presence server, document servers, the resource list server, and the like, as well as core networks communicate via one or more protocols. These protocols may include standardized protocols such as Session Initiation Protocol (SIP, IETF RFC3261), SIP-Specific Event Notification (IETF RFC 3265), XML Configuration Access Protocol (XCAP, IETF RFC4825) or other suitable protocols.

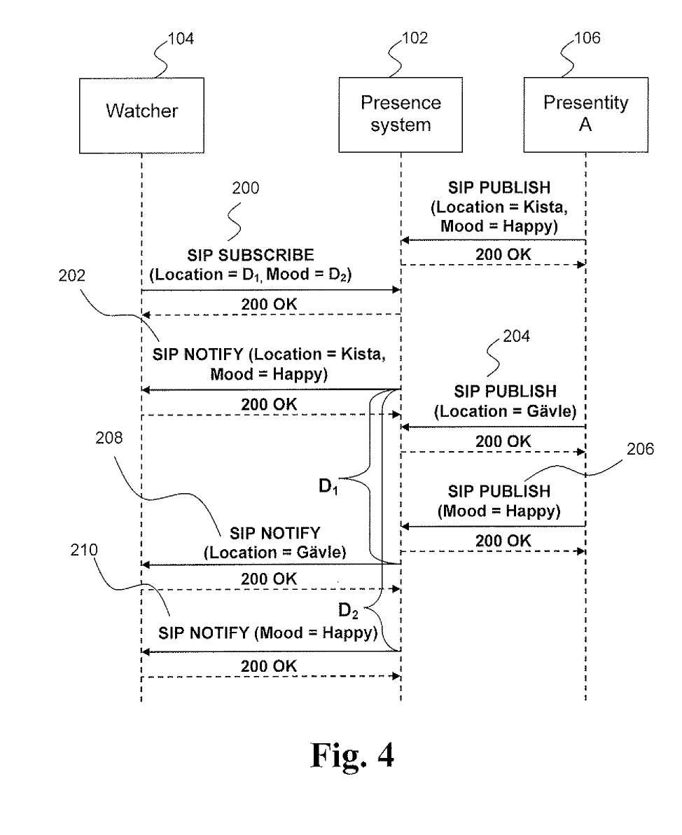

The method according to the invention may be embodied in a number of ways which will be described in more detail in connection with the FIGS. 4-12. The following description refers to entities in the presence system 102, however the present invention is not limited to the specific embodiment of the presence system but may be applied and adapted for any communication network adapted for presence.

FIG. 4 illustrates a general embodiment of the present invention. A Watcher 104 sends a first message 200 in the form of a subscription message, e.g. a SIP SUBSCRIBE, to the presence system 102. The first message 200 includes a first delay parameter D₁ to apply for a first presence parameter, the first presence parameter being the presence attribute “Location”, and a second delay parameter D₂ to apply for a second presence parameter, the second presence parameter being the presence attribute “Mood”. In response to the subscription message, the presence system 102 sends a notification 202 comprising presence data of the subscribed Presentity A 106. Subsequently, the Presentity A 106, who has changed it's location sends a second message 204 to the presence system 102 in the form of a publication message, e.g. a SIP PUBLISH, comprising the updated presence data (Location=Gävle) to the presence system 102. The presence system 102 receives the second message 204 and accordingly selects the first delay parameter value D₁, since the second message 204 indicates a change in the first presence parameter, i.e. a first attribute, and the first message sets D₁ to apply for the attribute “Location”. Subsequently, the presence system 102 sends a notification message 208, e.g. SIP NOTIFY, to the watcher 104 according to the selected delay parameter value D₁.

In case presentity A 106 has to update a second presence parameter, the presentity A 106 sends a second message 206 to the presence system 102 in the form of a publication message, e.g. a SIP PUBLISH, comprising the updated presence data (Mood=Happy) to the presence system 102. The presence system 102 receives the second message 206 and accordingly selects the second delay parameter value D₂ since the second message 204 indicates a change in the second presence parameter, i.e. a second attribute, and the first message sets D₂ to apply for the attribute “Mood”. Subsequently, the presence system 102 sends a notification message 210, e.g. SIP NOTIFY, to the watcher 104 according to the selected delay parameter value D₂,

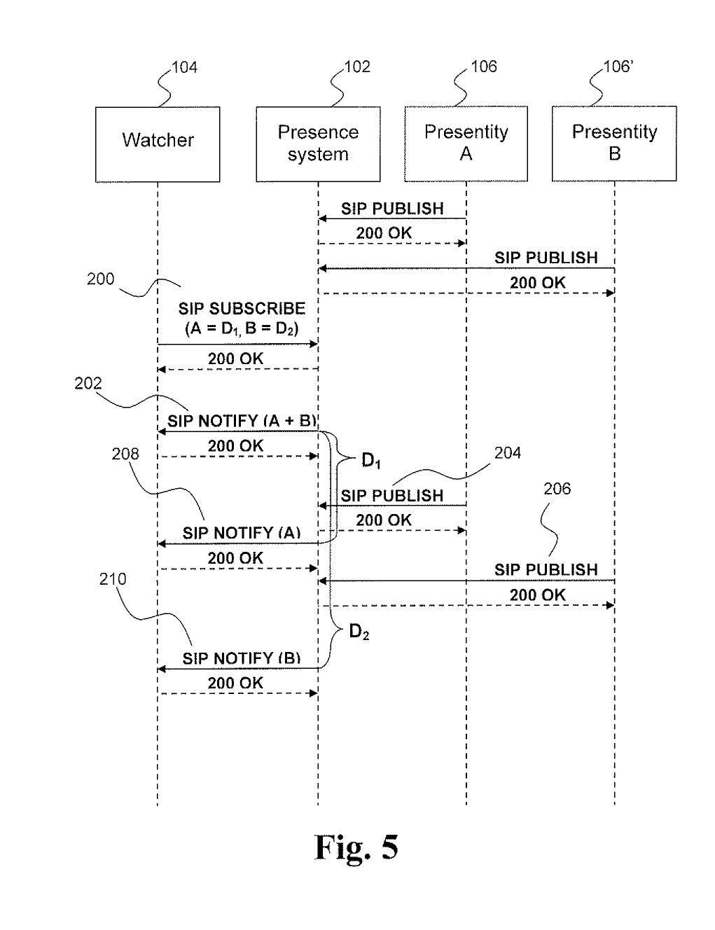

FIG. 5 illustrates an alternative embodiment of the present invention. The embodiments of FIG. 4 and FIG. 5 may be combined. A Watcher 104 sends a first message 200 in the form of a subscription message, e.g. a SIP SUBSCRIBE, to the presence system 102. The first message 200 includes a first delay parameter D₁ to apply for a first presence parameter, the first presence parameter being the presentity “A”, and a second delay parameter D₂ to apply for a second presence parameter, the second presence parameter being the presentity “B”. In response to the subscription message, the presence system 102 sends a notification 202 comprising presence data of the subscribed presentities A and B. Subsequently, presentity A 106, who has changed it's presence data sends a second message 204 to the presence system 102 in the form of a publication message, e.g. a SIP PUBLISH, comprising updated presence data to the presence system 102. The presence system 102 receives the second message 204 and accordingly selects the first delay parameter value D₁, since the second message 204 indicates a change for the first presence parameter, i.e. a first presentity, and the first message sets D₁ to apply for the presentity “A”. Subsequently, the presence system 102 sends a notification message 208, e.g. SIP NOTIFY, to the watcher 104 according to the selected delay parameter value D₁.

In case presentity B 106′ has to update presence data, the presentity B 106′ sends a second message 206 to the presence system 102 in the form of a publication message, e.g. a SIP PUBLISH, comprising the updated presence data to the presence system 102. The presence system 102 receives the second message 206 and accordingly selects the second delay parameter value D₂ since the second message 206 indicates a change for the second presence parameter, i.e. a second presentity, and the first message sets D₂ to apply for the presentity “B”. Subsequently, the presence system 102 sends a notification message 210, e.g. SIP NOTIFY, to the watcher 104 according to the selected delay parameter value D₂.

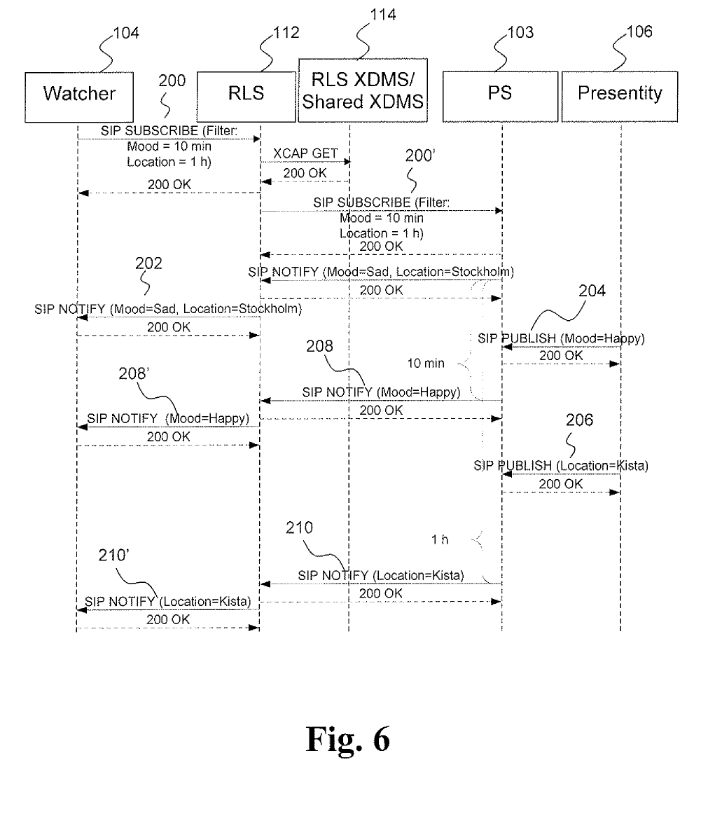

FIG. 6 illustrates an embodiment of the present invention. In this embodiment, the watcher filter schema is extended further to include throttle values for different presence attributes. The watcher 104 includes a watcher filter in the first message 200 when subscribing to presence data of presentities, e.g. presentity 106. In the watcher filter, the first delay parameter value (10 minutes) is set for the presence attribute Mood and the second delay parameter value (1 hour) is set for the presence attribute Location. The RLS 112 receives the first message 200 and sends a message 200′ including the watcher filter of the first message 200 to the presence server 103 via IMS Core. The RLS 112 sends a notification 202 with presence data of the subscribed presentity 106 based on a notification from the presence server 103. The presentity 106 needs to update first presence data and sends a second message 204 to the presence server 103. The presence server 103 selects the delay parameter in question (10 min) and accordingly sends a notification message 208 to the RLS 112 which forwards the updated presence data to the watcher 104 in a notification message 208′. In case the presentity 106 has to update second presence data, the presentity 106 sends a second message 206 to the presence server 103 comprising second presence data to be updated (Location=Kista). The presence server 103 selects the delay parameter in question (1 hour) and accordingly sends a notification message 210 to the RLS 112 which sends a notification message 210′ to the watcher 104 with the updated presence data.

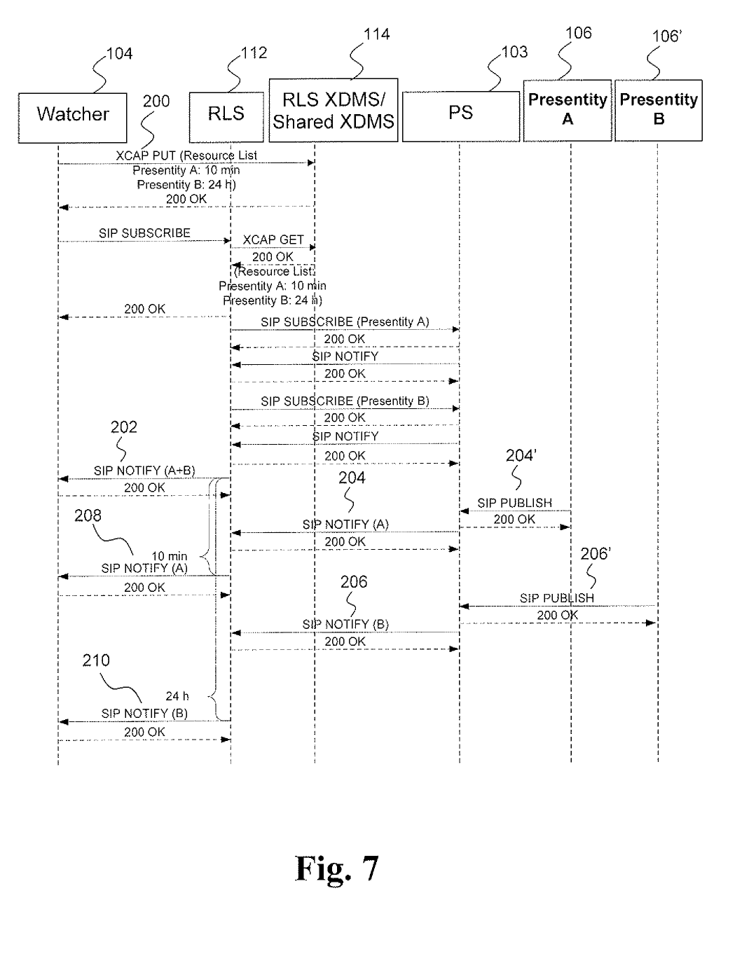

FIG. 7 illustrates a further embodiment of the present invention. In this embodiment, the rls-services and resource-list schemes are extended to also include throttle values for each entry or list defined. The watcher 104 sends a first message 200 to the RLS XDMS 114 in the presence network 102. In an embodiment, the first message 200 is sent to a Shared XDMS in the presence network 102. The first message 200 is an XCAP PUT message comprising a resource list defining contacts or presentities, where a first delay parameter value (10 min) is indicated for a first contact (Presentity A) or a first group of contacts and a second delay parameter value (24 hours) is indicated for a second contact (Presentity B) or a second group of contacts.

In FIG. 7, the RLS 112 handles the delay parameter values and sends notifications 208, 210 to the watcher 104 according to delay parameter values of the first message 200 and the presence data of the second messages 204, 206, respectively. The second messages 204, 206 are notifications from the presence server 103 in response to publication messages 204′ and 206′ from presentity A 106 and presentity B 106′, respectively.

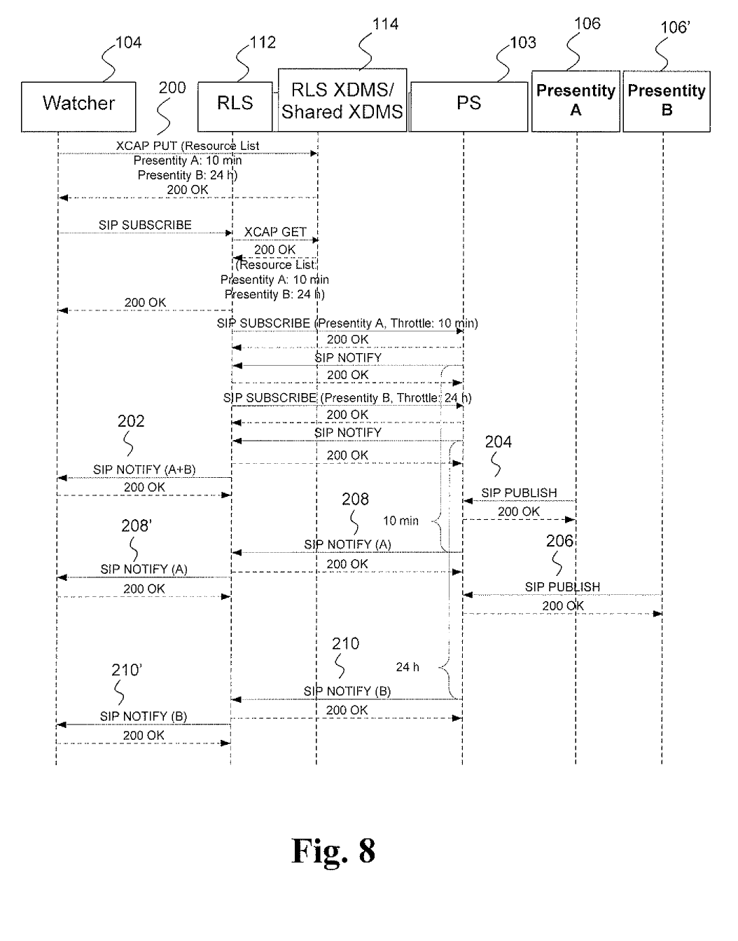

FIG. 8 illustrates a further embodiment of the present invention. In this embodiment, the RLS services and resource list schemas are extended to also include throttle values for each entry or list defined. The watcher 104 sends a first message 200 to the RLS XDMS 114 in the presence network 102. In an embodiment, the first message 200 is sent to a Shared XDMS in the presence network 102. The first message 200 is an XCAP PUT message comprising a resource list defining contacts or presentities, where a first delay parameter value (10 min) is indicated for a first contact (Presentity A) or a first group of contacts and a second delay parameter value (24 hours) is indicated for a second contact (Presentity B) or a second group of contacts. The RLS 112 receives a subscription from the watcher and retrieves the delay parameter values from the RLS XDMS 114 and forwards the delay parameter values to the presence server 103 in subscription messages.

In FIG. 8, the presence server 103 handles the delay parameter values and sends notifications 208, 210 to the RLS 112 according to delay parameter values of the first message 200 and the presence data of the second messages 204, 206, respectively. The second messages 204, 206 are publication messages from presentity A 106 and presentity B 106′, respectively. The RLS 112 forwards the information in the received notifications 208, 210 to the watcher 104 in notifications 208′, 210′, respectively.

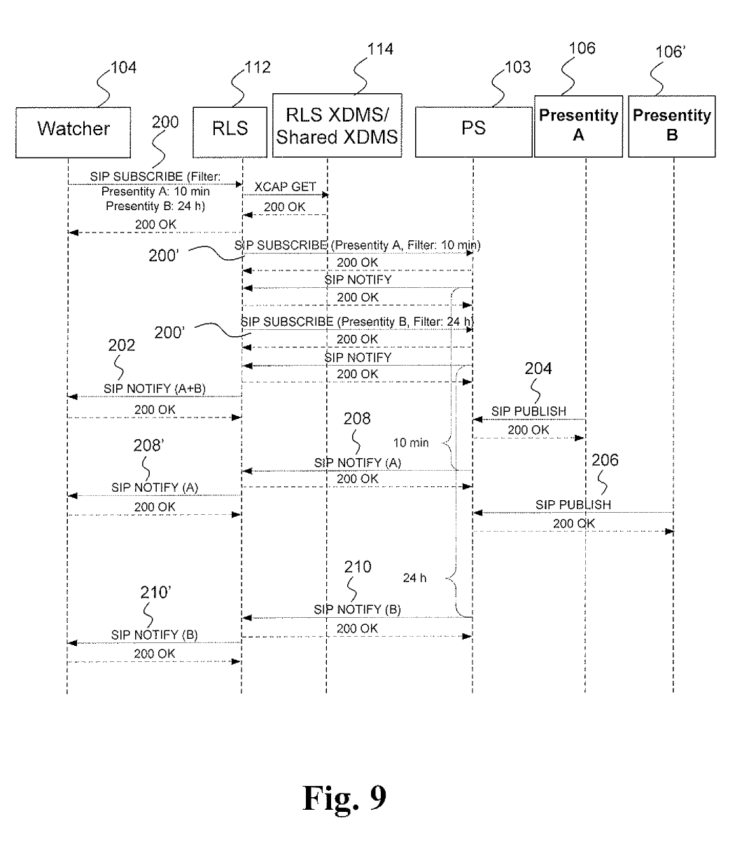

In the embodiment of FIG. 9, the watcher filter schema is extended further to include throttle values on contact level, i.e. delay parameter values for different presentities. The watcher 104 includes a watcher filter in the first message 200 when subscribing to presence data by sending a subscription message to the RLS 112. In the watcher filter, the first delay parameter value (10 minutes) is set for presentity A and the second delay parameter value (24 hours) is set for presentity B. The RLS 112 receives the first message 200 and splits the first message 200 to a number of subscription messages 200′ each comprising delay parameter value for the presentity in question. The subscription messages 200′ are sent to the presence server 103. The RLS 112 sends a notification 202 with presence data of the subscribed presentities to the watcher based on notifications from the presence server 103. Presentity A 106 needs to update presence data and sends a second message 204 to the presence server 103. The presence server 103 selects the delay parameter in question (10 min) and accordingly sends a notification message 208 to the RLS 112 which forwards the updated presence data to the watcher 104 in a notification message 208′. In case presentity B 106′ has to update second presence data, presentity B 106′ sends a second message 206 to the presence server 103 comprising second presence data to be updated. The presence server 103 selects the delay parameter in question (24 hours) and accordingly sends a notification message 210 to the RLS 112 which sends a notification message 210′ to the watcher 104 with the updated presence data.

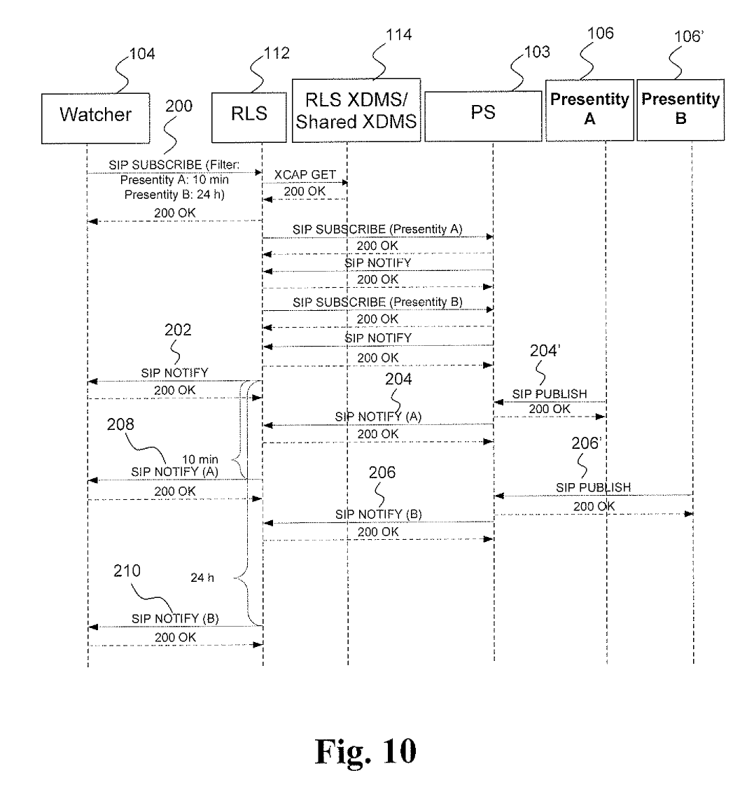

FIG. 10 shows an embodiment, where the RLS 114 handles the delay parameter values and the watcher filter schema is extended to include throttle values on contact level or presentities. The watcher includes a watcher filter in the subscription, wherein the watcher filter comprises delay parameter values for different presentities (10 min for presentity A, and 24 hours for presentity B).

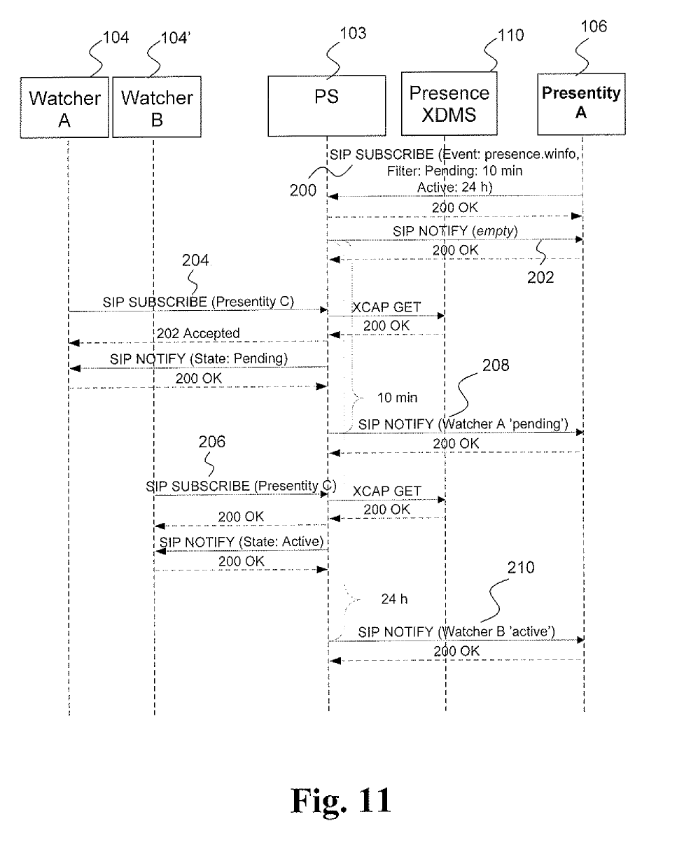

FIG. 11 illustrates an embodiment implementing throttle on Watcher Info notifications. Presentity A 106 requests throttle values for different states by sending a subscription request 200 to the presence server 103, the subscription message comprising a filter setting a first delay parameter value (10 minutes) for notification for “pending” state and a second delay parameter value (24 hours) for notifications for “active” state. The presence server 103 handles the subscription and sends notifications 208, 210 to presentity A 106 according to delay parameter values of the first message 200 and the second messages 204, 206 from watcher A 104 and watcher B 104′, respectively. In an embodiment, a third delay parameter may be set for a “waiting” state.

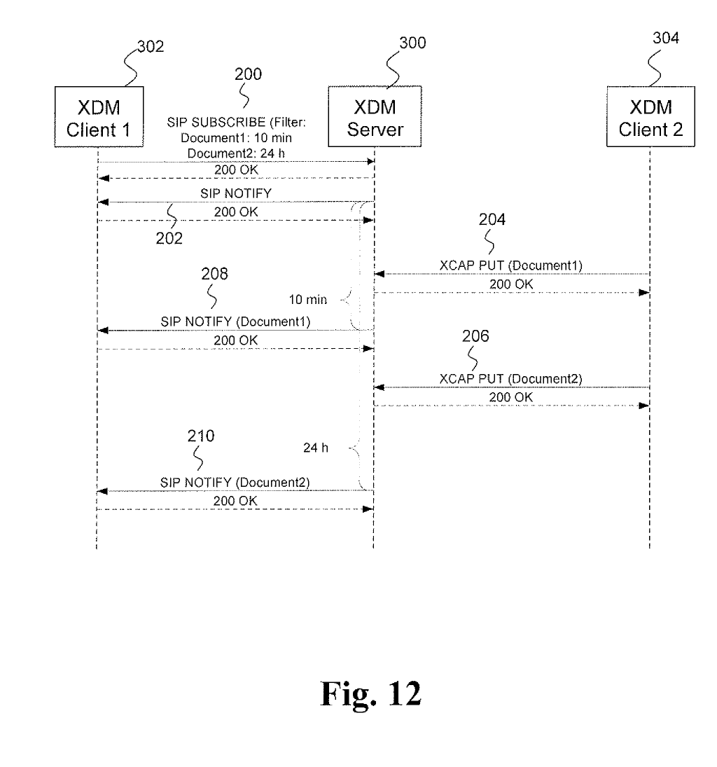

FIG. 12 illustrates an embodiment implementing throttle on notifications for document changes in a communication network comprising an XDM server 300, such as an IMS network, communicating with entities comprising a first entity and a second entity. In the sequence diagram, a first entity (XDM Client 1) 302 in the communication network, e.g. embodied in a watcher, sends a first message to the XDM server 300 with a filter setting different delay parameter values (throttle values) for document1 (10 minutes) and document2 (24 hours), respectively. In an embodiment of the present invention the second entity (XDM Client 2) 304 may send the first message. The XDM server 300 receives and confirms the subscription. When the second entity (XDM Client 2) 304 updates a document by sending a second message 204, 206, the XDM server 300 sends a notification to the first entity (XDM Client 1) 302 according to the requested delay parameter values.

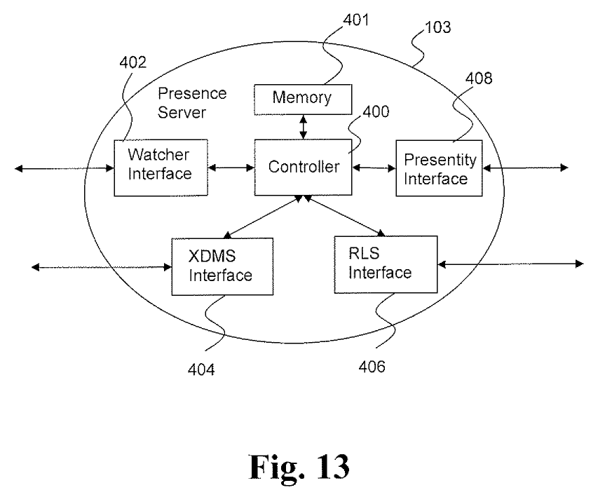

FIG. 13 is a function block diagram schematically illustrating a non limiting embodiment of the presence server 103 according to the invention. The presence server 103 comprises a controller 400 for controlling and coordinating the operation of the presence server. The controller 400 is adapted to control timing, type and content of messages sent to other entities in the system according to the present invention and is coupled to a memory 401 in the presence server 103. Further, the presence server 103 includes watcher interface 402, a presence XDMS interface 404, a RLS interface 406, and a presentity interface 408. The controller is coupled to the watcher interface 402 that is adapted to send and receive messages to or from a watcher connected to the communication network. Further, the controller is coupled to the presence XDMS interface 404 that is adapted to send and receive messages to or from the presence XDMS in the presence system 102. Further, the controller 400 is coupled to the RLS interface 406 enabling the presence server to communicate with the RLS 112 in the presence system 102. The presentity interface 408 enables communication with presentities by sending and receiving messages to or from presentities connected to the communication network. One or more of the interfaces 402, 404, 406, 408 to other entities may be combined into one interface.

In an embodiment, the presence server comprises an interface to a Shared XDMS

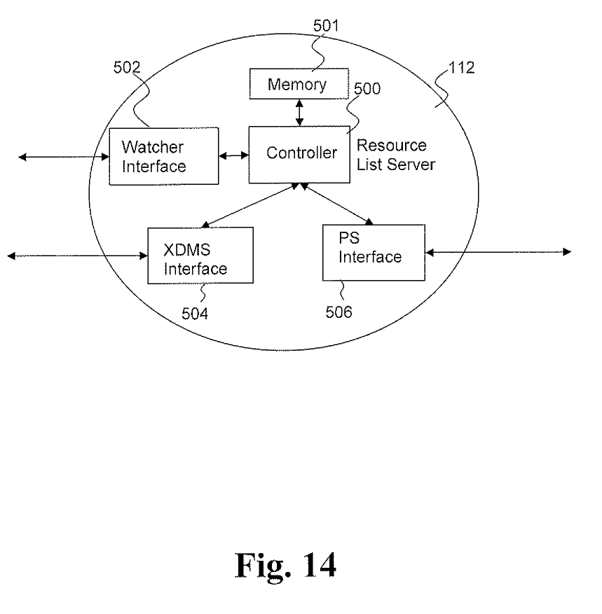

FIG. 14 is a function block diagram schematically illustrating a non limiting embodiment of the resource list server 112 according to the invention. The resource list server 112 comprises a controller 500 for controlling and coordinating the operation of the resource list server 112. The controller 500 is adapted to control timing, type and content of messages sent to other entities in the system according to the present invention and is coupled to a memory 501 in the resource list server 112. Further, the resource list server 112 includes watcher interface 502, a RLS XDMS interface 504, and a presence server interface 506. The controller 500 is coupled to the watcher interface 502 that is adapted to send and receive messages to or from a watcher connected to the communication network. Further, the controller 500 is coupled to the RLS XDMS interface 504 that is adapted to send and receive messages to or from the RLS XDMS 114 in the presence system 102. Further, the controller 500 is coupled to the presence server interface 506 enabling the resource list server 112 to communicate with the presence server 103 in the presence server 102. One or more of the interfaces 502, 504, 506 to other entities may be combined into one interface.

In an embodiment, the resource list server comprises an interface to a Shared XDMS

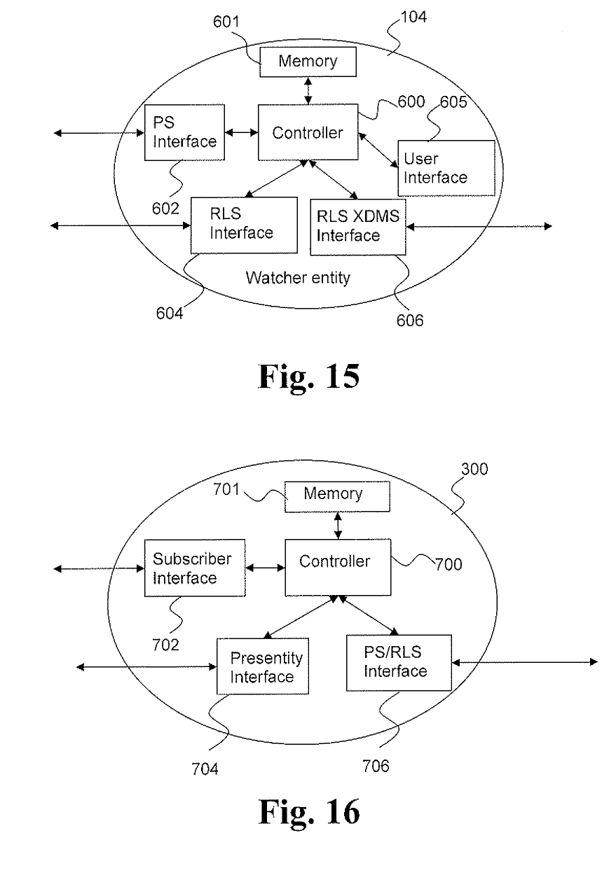

FIG. 15 is a function block diagram schematically illustrating a non limiting embodiment of the watcher entity 104 according to the invention. The watcher entity 104 comprises a controller 600 for controlling and coordinating the operation of the watcher entity 104. The controller 600 is adapted to control timing, type and content of messages sent to other entities in the system according to the present invention and is coupled to a memory 601 in the watcher entity 104. Further, the watcher entity 104 includes user interface 605, presence server (PS) interface 602, a RLS interface 604, and optionally a RLS XDMS interface 606. The controller 600 is coupled to the user interface 601 that is adapted to receive user input from a user enabling a user to set desired throttle values. The controller 600 is coupled to presence server interface 602 and RLS interface 604 in order to send and receive messages from a presence server 103 and a RLS 112, respectively. Preferably the interfaces 602 and 604 are adapted for wireless communication. In an embodiment, the controller is coupled to RLS XDMS interface 606 enabling the watcher entity to send and receive message to and from an RLS XDMS. The watcher entity 104 is adapted to send a first message to the presence system, e.g. via interfaces 602, 604, 606, wherein the first message comprising delay parameter values for different presence parameters. The delay parameter values may comprise a first delay parameter value for a first presence parameter and a second delay parameter value for a second presence parameter. The presence parameters may comprise a first presence attribute and a second presence attribute and/or a first presentity and a second presentity. Preferably, first message is a subscription message comprising a filter with the delay parameter values. In an embodiment, the first message is a PUT message comprising a resource list with the delay parameter values. The watcher entity may be a mobile terminal or an application server.

FIG. 16 is a function block diagram schematically illustrating a non limiting embodiment of the XDM server 300 according to the invention. The XDM server 300 comprises a controller 700 for controlling and coordinating the operation of the XDM server 300. The controller 700 is adapted to control timing, type and content of messages sent to other entities in the system, e.g. entities according to the present invention, and is coupled to a memory 701 in the XDM server 300. Further, the XDM server 300 includes subscriber interface 702, and a presentity interface 704. The XDM server 300 may be embodied in a XDM server in a presence SIMPLE network, e.g. in a Presence XDMS 110, and in that case the XDM server 300 according to the invention comprises a presence server (PS) interface 706. The presence server interface 706 may be omitted where the XDM server is used in an IMS/SIP system not necessarily adapted for presence. The controller 700 is coupled to the subscriber interface 702 that is adapted to send and receive messages to or from a subscriber to documents changes on the XDM server 300. Further, the controller 700 is coupled to the presentity interface 704 that is adapted to send and receive messages to and from presentities updating presence information on the XDM server 300. Further, the controller 700 may be coupled to the optional presence server/resource list server interface 706 that, if present, is adapted to send and receive messages to or from the presence server 103 and/or the resource list server 112 in the presence system 102. One or more of the interfaces 702, 704, 706 to other entities may be combined into one interface.

It should be noted that in addition to the exemplary embodiments of the invention shown in the accompanying drawings, the invention may be embodied in different forms and should not be construed as limited to the embodiments set forth herein. Rather, the embodiments illustrated herein are provided so that this disclosure will be thorough and complete, and will fully convey the concept of the invention to those skilled in the art.

1. Method for operating a communication network adapted to communicate with entities, the method comprising the steps of:
receiving a first message (200) from a first entity (104), the first message indicating delay parameter values (D₁, D₂) for different parameters,
receiving a second message (204, 206) from a second entity (106, 106′),
selecting a delay parameter value (D₁, D₂) depending on the received second message (204, 206) and the delay parameter values (D₁, D₂) in the first message (200), and
sending a notification (208, 210) to the first entity (104) according to the selected delay parameter value (D₁, D₂).

2. Method according to claim 1, wherein the step of receiving a first message comprises receiving a subscription message.

3. Method according to any of claims 1-2, wherein the step of receiving a first message comprises receiving a PUT message.

4. Method according to any of the preceding claims, wherein the step of receiving a second message comprises receiving a publication message.

5. Method according to any of the preceding claims, wherein the step of receiving a second message comprises receiving a subscription message.

6. Method according to any of the preceding claims, wherein the step of receiving a second message comprises receiving a PUT message.

7. Method according to any of the preceding claims, wherein the step of receiving a second message comprises receiving a notification message.

8. Method according to any of the preceding claims, wherein the delay parameter values in the first message apply to one or more presence attributes.

9. Method according to any of the preceding claims, wherein the delay parameter values in the first message apply to one or more presentities.

10. Method according to any of the preceding claims, wherein the step of selecting a delay parameter value comprises selecting a first delay parameter value (D₁) in case the second message comprises a first presence parameter and selecting a different second delay parameter value (D₂) in case the second message comprises a second presence parameter.

11. Method according to any of the preceding claims, wherein the step of sending a notification comprises sending a notification comprising updated presence data to a watcher.

12. Method according to any of the preceding claims, wherein the step of sending a notification comprises sending a notification comprising watcher info about a watcher to a watcher info subscriber.

13. Method according to any of the preceding claims, wherein the step of sending a notification comprises sending a notification about document changes on an XDM server in the presence system to a subscriber.

14. Method according to any of the preceding claims, wherein the step of selecting a delay parameter value comprises selecting a throttle value.

15. Method according to any of the preceding claims, wherein the step of selecting a delay parameter value comprises selecting a rate limitation value.

16. Method according to any of the preceding claims, further comprising the step of:
storing the delay parameter values (D₁, D₂) for different parameters in a memory in the presence system.

17. A presence server (103) for a presence system (102) for communicating with entities, comprising a memory and wherein the presence server is adapted to:
receive a first message (200) from a first entity (104, 112), the first message indicating delay parameter values (D₁, D₂) for different presence parameters,
receive a second message (204, 206) from a second entity (106, 106′),
selecting a delay parameter value (D₁, D₂) in the presence system depending on the received second message (204, 206) and the delay parameter values (D₁, D₂) in the first message (200),
select a delay parameter value (D₁, D₂) depending on the received second message (204, 206) and the delay parameter values (D₁, D₂) in the first message (200), and
send a notification (208, 210) to the first entity (104, 112) according to the selected delay parameter value (D₁, D₂).

18. A presence server according to claim 17, wherein the first message is a subscription message comprising a filter identifying the delay parameter values for different presence parameters.

19. A presence server according to any of claims 17-18, wherein the first message is a PUT message identifying the delay parameter values for different presence parameters.

20. A presence server according to any of the claims 17-19, wherein the second message is a publication message.

21. A presence server according to any of the claims 17-19, wherein the second message is a subscription message.

22. A presence server according to any of the claims 17-19, wherein the second message is a PUT message.

23. A presence server according to any of the claims 17-22, wherein the delay parameter values in the first message apply to one or more presence attributes.

24. A presence server according to any of the claims 17-23, wherein the delay parameter values in the first message apply to one or more presentities

25. A presence server according to any of claims 17-24, wherein the presence server is adapted to select a first delay parameter value in case the second message comprises a first presence parameter and adapted to select a different second delay parameter value in case the second message comprises a second presence parameter.

26. A presence server according to any of claims 17-25, wherein the presence server is adapted to send a notification comprising updated presence data.

27. A presence server according to any of claims 17-26, wherein the presence server is adapted to send a notification comprising watcher info about a watcher.

28. A presence server according to any of claims 17-27, wherein the presence server is adapted to send a notification about document changes on an XDM server in the presence system.

29. A presence server according to any of claims 17-28, wherein the presence server is adapted to select a throttle value and send a notification according to the selected throttle value.

30. A presence server according to any of claims 17-29, wherein the presence server is adapted to select a rate limitation value and send a notification according to the selected throttle value.

31. A presence server according to any of the claims 17-30, wherein the presence server is further adapted to store the delay parameter values for different presence parameters in a memory in the presence system (102).

32. A resource list server (112) for a presence system (102) for communicating with entities (103, 104, 106), wherein the resource list server (112) is adapted to:
receive a first message (200) from a first entity (104), the first message indicating delay parameter values (D₁, D₂) for different presence parameters,
receive a second message (204, 206) from a second entity (103),
select a delay parameter value (D₁, D₂) depending on the received second message (204, 206) and the delay parameter values (D₁, D₂) in the first message (200), and
send a notification (208, 210) to the first entity (104) according to the selected delay parameter value (D₁, D₂).

33. A watcher entity (104) for a communication network (100) comprising a presence system (102), wherein the watcher entity is adapted to send a first message to the presence system, the first message comprising delay parameter values for different presence parameters.

34. A watcher entity according to claim 33, wherein the first message comprises a first delay parameter value for a first presence parameter and a second delay parameter value for a second presence parameter.

35. A watcher entity according to any of claims 33-34, wherein the presence parameters comprise a first presence attribute and a second presence attribute.

36. A watcher entity according to any of claims 33-35, wherein the presence parameters comprise a first presentity and a second presentity.

37. A watcher entity according to any of the claims 33-36, wherein the first message is a subscription message comprising a filter with the delay parameter values.

38. A watcher entity according to any of the claims 33-36, wherein the first message is a PUT message comprising a resource list with the delay parameter values.

39. A watcher entity according to any of the claims 33-37, wherein the watcher entity is a mobile terminal.

40. A XDM server (300) for a communication network communicating with entities including a first entity (302) and a second entity (304), wherein the XDM server (300) is adapted to:
receive a first message (200) from an entity (302, 304), the first message indicating delay parameter values (D₁, D₂) for different documents,
receive a second message (204, 206) from the second entity (304),
select a delay parameter value (D₁, D₂) depending on the received second message (204, 206) and the delay parameter values (D₁, D₂) in the first message (200), and
send a notification (208, 210) to the first entity (302) according to the selected delay parameter value (D₁, D₂).

41. A XDM server (300) according to claim 40, wherein the XDM server (300) is adapted to receive the first message from the first entity (302).

42. A XDM server (300) according to claim 41, wherein the XDM server (300) is adapted to receive the first message from the second entity (304).
